(19) United States
(12) Patent Application Publication
(10) Pub. No.: US 2021/0063840 A1
(43) Pub. Date: Mar. 4, 2021

(54) Phase Difference Measurement Device for Optical Phased Arrays

(71) Applicant: IMEC VZW, Leuven (BE)

(72) Inventors: Bruno Figeys, Herent (BE); Jon Kjellman, Leuven (BE); Xavier Rottenberg, Kessel-Lo (BE); Roelof Jansen, Heverlee (BE)

(21) Appl. No.: 16/998,551

(22) Filed: Aug. 20, 2020

(30) Foreign Application Priority Data
Aug. 27, 2019 (EP) 19193674.9

(51) Int. Cl. G02F 1/29; G02F 1/225; G01S 7/481; G01S 17/88

(52) U.S. Cl. CPC G02F 1/292; G01S 17/88; G01S 7/4817; G02F 1/225

(57) ABSTRACT

A phase difference measurement device comprises at least two optical waveguides arranged in parallel in a first plane. Each optical waveguide comprises a proximal portion and a distal portion. The proximal portion of at least one of the optical waveguides comprises a phase-shifting device configured to induce a phase shift of a light wave being transmitted in the phase difference measurement device. The device further comprises at least one phase interrogator device arranged in the first plane between two neighboring optical waveguides of the optical waveguides. The phase interrogator device is configured to couple light from the two neighboring optical waveguides to interfere in the phase interrogator to generate an interference light wave. At least one photodetector is arranged for detecting the interference light wave. The photodetector is arranged in a second plane other than the first plane.

### CROSS-REFERENCE TO RELATED APPLICATIONS

The present application is a non-provisional patent application claiming priority to European Patent Application No. 19193674.9, filed Aug. 27, 2019, the contents of which are hereby incorporated by reference in their entirety.

### FIELD OF THE DISCLOSURE

This application relates to the field of optical phased arrays. More particularly, the application relates to a device for measuring the phase difference between waveguides in an optical phased array.

### BACKGROUND

Optical phased arrays are relevant devices for beamforming and holography applications. Among other applications, an optical beam former can be used as a key component of a light detection and ranging (LiDAR) system. LiDAR is currently becoming an important technology for implementation in autonomous vehicles.

A phased array consists of an array of antennas that emit waves that interfere with one another. The waves may, for example, be acoustic waves or electromagnetic waves. By controlling the phase of the waves emitted by the different antennas, the wavefront of the wave can be designed to focus on a region of the near-field of the antenna array. However, phased arrays are often designed to emit light in a well-defined direction, and this direction may be controlled or changed by controlling the phase of the waves being emitted by the antennas. In practice, amplitude modulation of the waves emitted by the different antennas can be used to further optimize the achieved beam.

Recently, research has been conducted towards the development of complementary metal-oxide-semiconductor (CMOS) compatible optical phased arrays with integrated photonics to miniaturize such systems. Key to such phased arrays is to have accurate control over the phase of the light being emitted by the antennas because of the loss of phase control results in noise in the far-field pattern. However, typical waveguide architectures for addressing the different antennas introduce phase errors due to fabrication imperfections, thereby leading to accumulation of phase errors, which can lead to noise in the far-field.

As an example, document WO2018160729 discloses a three-dimensional (3D) optical sensing system for a vehicle. A presented approach for the steering mechanism is the use of a phased optical array of optical micro antennas or emitters. In the phased array of optical micro antennas, each antenna may be made by etching a grating into a waveguide that radiates the light out of the waveguide.

### SUMMARY

It is an object of the application to at least partly overcome one or more limitations of the prior art. In particular, it is an object to provide a phase difference measurement device for optical phased arrays.

In a first aspect, a phase difference measurement device for optical phased arrays is provided. The phase difference measurement device comprises:
At least two optical waveguides arranged in parallel in a first plane. Each optical waveguide comprises a proximal portion and a distal portion. The proximal portion of at least one of the two optical waveguides further comprises a phase-shifting device configured to induce a phase shift of a light wave being transmitted in the phase difference measurement device,
At least one phase interrogator device arranged in the first plane between two neighboring optical waveguides of the two optical waveguides. The phase interrogator device is configured to couple light from the two neighboring optical waveguides to interfere in the phase interrogator to generate an interference light wave, and
At least one photodetector arranged for detecting the interference light wave. The photodetector is arranged in a second plane other than the first plane.

The phase difference measurement device, therefore, facilitates measuring the phase difference between two optical waveguides, which are suitable for transmitting electromagnetic waves. One or more of the optical waveguides may comprise SiN.

In some examples, the optical waveguides are further arranged in parallel in a first plane. However, the optical waveguides may have other portions that are not arranged in parallel or arranged in other planes. The optical waveguides may be straight or bent or comprise both straight or bent portions.

Examples of the optical waveguides have a cross-section that is less than 1 μm, or less than 500 nm.

Examples of the optical waveguides are silicon waveguides having an oxide cladding (SOI).

Each waveguide comprises a first end and a second end. Thus, each waveguide has a proximal and distal portion. The proximal portion is arranged at the first end, and the distal portion is arranged at the second end. The proximal portion of at least one of the two optical waveguides further comprises a phase-shifting device configured to induce a phase shift of a light wave being transmitted in the optical waveguides. The phase-shifting device may be a tunable phase-shifting device in which the degree of phase shift may be varied.

Not all optical waveguides require a phase-shifting device. The phase-shifting device may, therefore, be configured to change the phase of incoming light at the proximal portion of the optical waveguide.

Furthermore, in some examples, there is at least one phase interrogator device arranged in the first plane between two neighboring optical waveguides. The phase interrogator device is configured to couple light from each respective optical waveguide an allow light from the respective optical waveguides to interfere. This, in turn, generates an interference light wave in the phase interrogator device. The phase interrogator device may, therefore, correspond to a waveguide, such as a single-mode waveguide or a multimode waveguide or any other sub-component in which interference can take place. Consequently, the phase interrogator is configured such that a fraction of the light waves being transmitted in two neighboring optical waveguides is tapped off from the waveguides and interfered.

In some examples, the phase difference measurement device comprises a photodetector arranged in a second plane, which is a plane different than the first plane. In these examples, the photodetector is configured to measure the intensity of the interference light wave, and the amplitude of detected interference light is related to the phase difference of the two neighboring optical waveguides. In some examples, the photodetector is configured for converting the light intensity to an electrical signal.

The first aspect is based on the insight that it is valuable to measure the phase difference between neighboring waveguides, because this may be used to control how much the light wave in one or several optical waveguides are to be shifted. If the phase difference measurement device is used in a phased array, the phase difference measurement facilitates achieving the desired angular precision. Furthermore, by having the photodetector for detecting the interference light wave out-of-plane, i.e., in another plane than the optical waveguides and the phase interrogator, the whole phase difference measurement device may be manufactured with a more compact design, thereby making the whole phase difference measurement device suitable in a CMOS compatible optical phased array. The first aspect thus provides a miniaturized component intended to measure the phase difference between two light waves in two different waveguides.

In embodiments of the first aspect, the phase difference measurement device further comprises a control unit configured to control the phase shifting device such that the phase is shifted with a value based on information of the detected interference light wave received by the photodetector.

Therefore, the control unit facilitates feedback control, e.g., for controlling the amount of phase shift applied based on the actual measured phase shift in the optical waveguides. This, in turn, may reduce the risk of phase errors due to fabrication imperfections of the optical waveguides.

The control unit may, therefore, be configured to receive a signal corresponding to the intensity of the light detected in the photodetector and further be configured to control the degree of phase shift in one or several phase shifters.

As an example, there may be one control unit per phase interrogator device. Alternatively, a single control unit is configured to control several phase shifters and also configured to receive information from several photodetectors.

The control unit may comprise a processor and a communication interface for communicating with photodetectors and phase shifters and for receiving information from photodetectors. An example of the control unit further comprises computer program products configured for sending operational requests to one or several phase shifters. The operational requests may be based on the analysis of received data from one or several photodetectors. An example of the control unit comprises a processing unit, such as a central processing unit, which is configured to execute computer code instructions stored on a memory.

An example of the control unit is configured to control the phase shifting device such that the phase shift between the two optical waveguides is kept within a predefined interval.

The control unit may, therefore, facilitate steering the degree of phase shifting such that degree of phase shifting is kept within an interval, such as at a reference value, below a reference value, or above a reference value.

An example of the control unit comprises integrated circuits constructed by CMOS technology.

An example of the control unit is manufactured by CMOS technology and may implement logic operations that facilitate controlling phase shifter or phase-shifting devices that are driven by integrated circuits constructed by CMOS technology.

In embodiments of the first aspect, the phase interrogator device is configured to direct the interfered light in a direction toward the photodetector in the second plane.

Because the photodetector is arranged out-of-plane from the phase interrogator, the phase interrogator itself may be configured to direct the interference light wave to the photodetector.

An example of the phase interrogator may comprise a reorientation portion in the form of a grating mirror or a lattice of scatterers for scattering the interfered light wave toward the photodetector in the second plane.

The reorientation portion may be an area that includes well-defined scatterers, such as a periodic lattice of scatterers, for directing the interference light waves to the photodetectors.

In embodiments of the first aspect, the photodetector comprises a PN-diode. The PN-diode comprises a P-N junction and may be configured to operate in reverse bias condition. As an example, the PN-diode may be a silicon PN-photodetector. Such a PN-diode may be useful for wavelengths that are absorbed by silicon, such as wavelengths between 300 nm-1000 nm. An example of the photodetector is configured to detect light having a wavelength of about 905 nm, in which case the waveguides of the phase difference measurement device may be configured for transmitting light waves of this wavelength.

Alternatively, the photodetector may comprise Ge on Si. Such detectors may be useful in near-infrared (NIR) applications, such as for wavelengths between 1300 and 1550 nm.

In embodiments of the first aspect, at least one phase-shifting device of the two optical waveguides is a thermo-optic phase shifter. The thermo-optic phase shifter may be configured to thermally change the refractive index of the material in the optical pathway in the phase shifter, thereby providing a modulation of the light wave, such as a phase shift. An example of the thermo-optic phase shifter comprises a resistance heater thermally coupled to the high index core of a silica waveguide.

However, it is to be understood that other types of phase-shifting devices may be used in the phase difference measurement device of the first aspect.

The optical waveguides and the phase interrogators may be arranged such that a light wave being transmitted in at least one optical waveguide is coupled into two phase interrogator devices, one on each side of the waveguide.

Therefore, in some examples of the first aspect, the phase difference measurement device comprises a plurality of optical waveguides, and a phase interrogator device is arranged between each two neighboring optical waveguides.

Therefore, a plurality of optical waveguides and phase interrogator devices may be alternatively arranged in the first plane.

As an example, the phase difference measurement device comprises at least 100, or at least 1000, optical waveguides with phase interrogator devices arranged in between pairs of optical waveguides.

An example of the phase difference measurement device comprises a number of phase interrogator devices such that there is no phase interrogator device arranged between at least some neighboring optical waveguides. Therefore, in some examples, only a few of the induced phase shifts that are induced within the whole device are measured, and in some embodiments, controlled. An example of the phase difference measurement device comprises a plurality of optical waveguides and X number of phase-shifting devices. The number of phase interrogators may then be less than X−1, less than X−10, less than X/2, etc.

In an example, the plurality of optical waveguides extend from the proximal portion to the distal portion in an X direction. In these examples, two adjacent phase interrogators are arranged in the first plane at different positions along the X direction.

By arranging the phase interrogators at different positions in the X direction, the phase difference measurement device may be provided in a more compact form factor.

In a second aspect, a phased array is provided. The phased array comprises:
At least one phase difference measurement device according to the first aspect,
An optical antenna arranged on each distal portion of the optical waveguides of the at least one phase difference measurement device,
A receiving waveguide for receiving light waves that are to be transmitted by the optical phased array, and
A coupling arrangement for transmitting and splitting the light waves received by the receiving waveguide to the phase-shifting devices of the at least one phase difference measurement device.

The effects and features of this second aspect are largely analogous to those described above in connection with the first aspect. Embodiments mentioned in relation to the first aspect are largely compatible with the second aspect.

The phased array may be suitable for emitting light waves in well-defined directions, depending on the phase of the light waves being emitted by the antennas, i.e., depending on the degree of phase shift applied by the phase-shifting devices of the phase difference measurement devices. By controlling the phase shift between neighboring waveguides with the phase interrogator devices, the number of errors of the emitted light waves in the far-field may be decreased.

Examples of the optical antennas correspond to leaky-wave antennas (LWA). Each optical antennas may comprise a waveguide having protrusions from which the light is emitted.

The receiving waveguide is configured to receive light transmitted by the antenna. A coupling arrangement is arranged between the receiving waveguide and the phase difference measurement devices. The coupling arrangement is used as a splitter tree for splitting the receiving light in a number of paths, such as one path for each phase-shifting device.

An example of the coupling arrangement comprises a plurality of optic couplers configured to split light waves into at least two paths. The optic couplers may, for example, be 1×2 port multimode interference (MMI) couplers.

An example of the phased array comprises at least 100, at least 1000, etc. optical antennas. The phased array may, therefore, be suitable for use in a light detection and ranging (LiDAR) system.

In a third aspect, a LiDAR system for measuring the distance to a target is provided. The LiDAR system comprises:
A light source for generating light waves for illuminating the target,
An optical phased array according to the second aspect above for controlling the illumination direction of the light waves generated by the light source, and
A sensor device for measuring the reflected light of the emitted light waves from the target.

The effects and features of the third aspect are largely analogous to those described above in connection with the first and the second aspects. Embodiments mentioned in relation to the first and the second aspects are largely compatible with the second aspect.

An example of the LiDAR system is suitable for use in an autonomous car for measuring the distance to objects around the car.

An example of the light source corresponds to a laser light source. An example of the light source is configured to generate light waves having a wavelength between 300 nm-1000 nm, such as wavelengths around 905 nm. The light source is further arranged for generating light that is received by the receiving waveguide of the phased array.

An example of the sensor device comprises photodetectors configured to detect the reflected light from the target.

### BRIEF DESCRIPTION OF THE FIGURES

The above, as well as additional features, will be better understood through the following illustrative and non-limiting detailed description of example embodiments, with reference to the appended drawings. In the drawings like reference numerals will be used for like elements unless stated otherwise.

FIG. 1 is a schematic illustration of a phase difference measurement device for optical phased arrays, according to an embodiment.

FIG. 2 is a schematic illustration of a phase difference measurement device for optical phased arrays, according to an embodiment.

FIG. 3A is a schematic illustration of a phase difference measurement device comprising a control unit, according to an embodiment.

FIG. 3B is a side view of a phase difference measurement device manufactured by CMOS technology, according to an embodiment.

FIG. 4 is a schematic illustration of an optical phased array, according to an embodiment.

FIG. 5 is a schematic illustration of an LWA that may be used in an optical phased array, according to an embodiment.

FIG. 6 is a close-up view of the optical phased array of FIG. 4, according to an embodiment.

All the figures are schematic, not necessarily to scale, and generally only show parts that are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

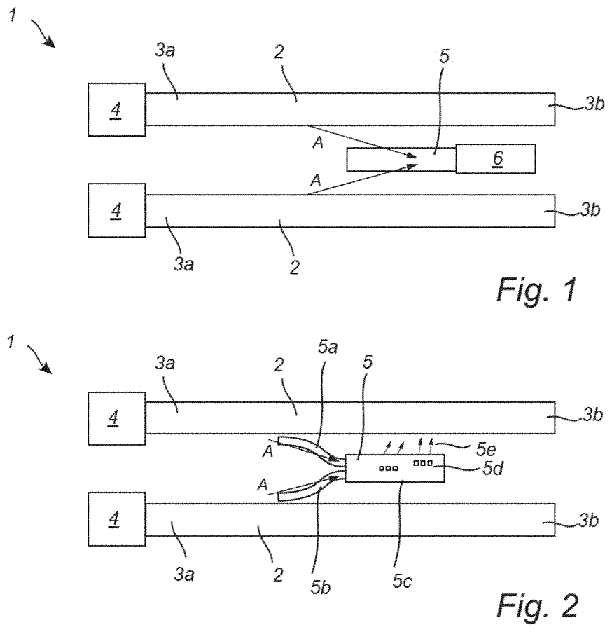

FIG. 1 shows a top view of an embodiment of a phase difference measurement device 1 for optical phased arrays according to an embodiment. The phase difference measurement device 1 comprises two optical waveguides 2 arranged in parallel in a first plane. Each optical waveguide 2 comprises a proximal portion 3a and a distal portion 3b. Light transmitted in a waveguide 2 may be guided from the proximal portion 3a to the distal portion 3b. The proximal portion 3a of both optical waveguides further comprises a phase-shifting device 4 configured to induce a phase shift of a light wave being transmitted in the phase difference measurement device 1.

The two phase-shifting devices may be thermo-optic phase shifters, and may be configured to shift the phase of the light waves such that a light wave transmitted in one of the waveguides has a different phase compared to a light wave being transmitted in the other waveguide.

A phase interrogator device 5 is arranged in the same plane as the two optical waveguides and in between the two waveguides 2. The phase interrogator device 5 is configured to couple light from each respective optical waveguide 2, as indicated by arrows “A” in FIG. 1. The phase interrogator device 5 allows the light from each respective optical waveguide 2 to interfere in the phase interrogator 5 to generate an interference light wave. The phase interrogator 5 may thus be positioned at a distance from the two optical waveguides such that light from both waveguides may be coupled into the phase interrogator device 5. The photodetector 6 of the device 1 is arranged out-of-plane, i.e., in a second plane other than the first plane in which the optical waveguides and the phase interrogator are arranged. The phase interrogator 5 may also be configured to direct the interference light wave to the photodetector, i.e., phase interrogator may be arranged to extend in both the first and second plane.

Consequently, the phase difference measurement device 1 is arranged so that the interference light wave from the phase interrogator 5 is sent to a photodetector 6 that is placed remote from the closely spaced optical waveguides. The amplitude of detected interference light wave in the photodetector 6 is related to the phase difference and may, therefore, be used for measuring the phase difference between the light waves being transmitted in the two optical waveguides 2.

FIG. 2 shows a further embodiment of a phase difference measurement device 1. In this embodiment, the phase interrogator 5 is in itself a waveguide having a Y-shape. The phase interrogator 5 thus comprises a central portion 5c and two arms 5a, 5b arranged in the first plane such that a first arm 5a is closer to a first optical waveguide 2, and a second arm 5b is closer to the other optical waveguide 2. The arms 5a and 5b are thus arranged such that a fraction of the optical power of light waves being transmitted in the optical waveguides 2 may be tapped off. The light that has been coupled into the phase interrogator 5, as indicated by arrows “A,” is then allowed to interfere in the central portion 5c and then sent to the photodetector 6. In this example, the arms 5a and 5c of the Y-shaped phase interrogator device 5 are bent in the first plane and have, for example, an S-shape in the first plane. However, examples of the arms 5a and 5b can have a straight shape. Furthermore, the phase interrogator 5 is configured to direct the interfered light wave 5e in a direction toward a photodetector (not shown in FIG. 2) in the second plane. In an example, to facilitate directing the interfered light wave 5e, the phase interrogator 5 comprises a reorientation portion 5d, which could, for example, be a grating mirror or a lattice of scatterers.

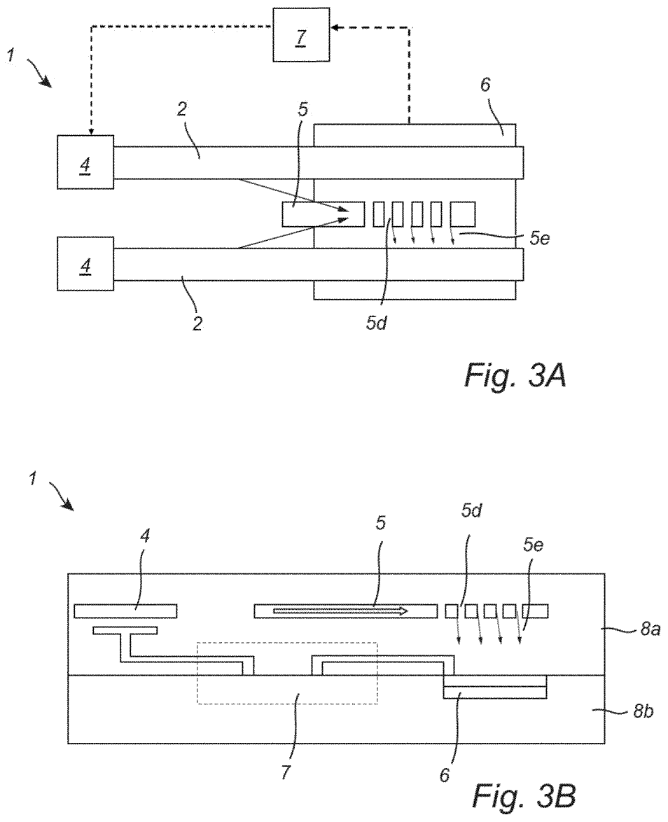

FIG. 3A shows an embodiment of a phase difference measurement device 1 that also comprises a control unit 7. The device 1 functions as discussed in relation to FIGS. 1 and 2 above. For example, a fraction of the light is tapped off from the waveguides 2, interfered in the phase interrogator 5, and directed from a lattice structure in the reorientation portion 5d of the phase interrogator 5 to a photodetector 6 arranged in another plane for measuring the optical intensity.

Information of the optical intensity is communicated as an electric signal to the control unit 7, which is configured to control the phase-shifting devices 4 such that the phase is shifted with a value based on information of the detected interference light wave in the photodetector 6. An example of the control unit 7 communicates signals to the phase-shifting devices 4 based on the received information and, therefore, forms part of a feedback loop for controlling the amount of phase shift applied by the phase-shifting devices 4. An example of the control unit 7 is, therefore, configured to regulate the phase shift based on received information from the photodetector 6. For this purpose, the control unit 7 may comprise a device having processing capability in the form of processing unit, such as a central processing unit, which is configured to execute computer code instructions, which for instance, may be stored on a memory. The memory may thus form a computer-readable storage medium for storing such computer code instructions. The processing unit may alternatively be in the form of a hardware component, such as an application-specific integrated circuit, a field-programmable gate array, or the like. The processing unit may further comprise computer code instructions for sending operational requests to the phase-shifting devices 4.

In some examples, the control unit 7 is configured to measure the phases and/or phase differences continuously or at discrete time points. In an example, the control unit 7 is configured to measure the phase difference at discrete time points, and if the phase difference needs to be adjusted, operational requests are communicated to the phase-shifting devices 4. In this example, the control unit 7 is configured to control the phase-shifting devices 4 such that the phase shift between the two optical waveguides is kept within a predefined interval.

FIG. 3B shows a side view an embodiment of a phase difference measurement device 1 partly manufactured using CMOS technology. The device 1 comprises a first layer 8a in which the optical waveguides 2, the phase-shifting devices 4, and the phase interrogator 5 are arranged. A second layer 8b in the form of a silicon layer is arranged below the first layer 8a. The photodetector 6 in the form of a PN-diode is arranged in the second layer 9. In this example, the control unit 7 is provided in the form of an integrated circuit(s) and is arranged in the second layer 8b. An example of the integrated circuit(s) may be manufactured using CMOS technology and may be configured to perform logic operations, thereby functioning as a feedback control. The logic operations may be used to regulate the phase-shifting devices 4 based on the detected light intensity of the photodetector 6, i.e., based on the amount of detected interference light waves 5e. In other words, the phase-shifting devices, such as thermo-optic phase shifter, may be driven by the CMOS.

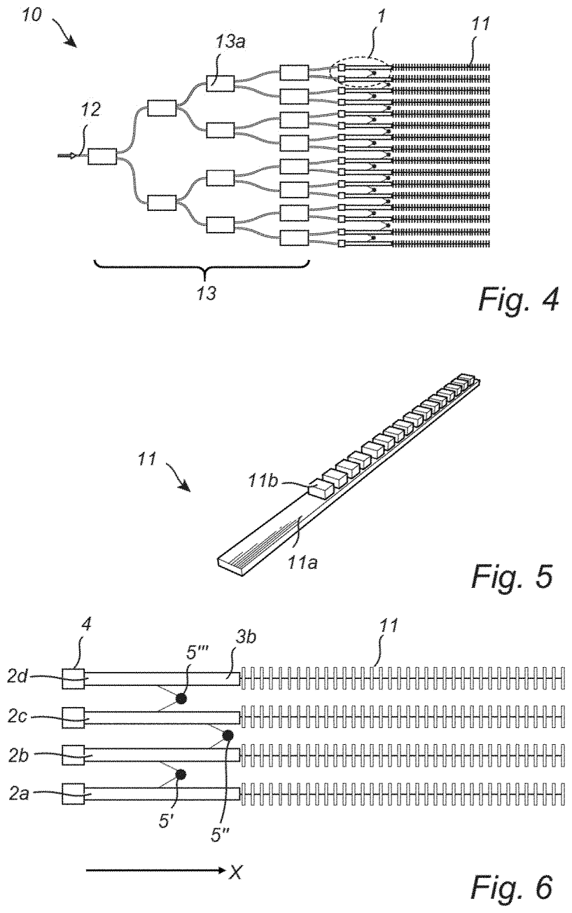

FIG. 4 shows an embodiment of a phased array 10, such as an optical phased array (OPA), which comprises a phase difference measurement device 1 as discussed in relation to FIGS. 1-3 above. The phase difference measurement device 1 comprises a plurality of optical waveguides 2. A phase interrogator device 5 is arranged between each neighboring optical waveguide 2. An optical antenna 11 is arranged on the distal portion of each of the optical waveguides 2. The optical antenna functions as a radiating element that couples the receiving light into free space. Radiated light by the optical antennas may be combined in the far-field and, by adjusting the relative phase shift between the light being transmitted to the different antennas 11, a beam can be formed and steered.

An example of the optical antenna 11 corresponds to a leaky-wave antenna (LWA), which is further illustrated in FIG. 5. Such an LWA 11 may comprise an elongated waveguide portion 11a and a plurality of protrusions 11b at the most distal end of the elongated waveguide portion 11a. The protrusions 11b facilitate emitting the light being transmitted to the LWA 11 in an efficient manner.

The phased array 10 further comprises a receiving waveguide 12 for receiving light waves that are to be transmitted by the optical phased array 1 as well as a coupling arrangement 13 for transmitting and splitting the light waves received by the receiving waveguide 12 to the phase-shifting devices 4 of the phase difference measurement device 1.

The coupling arrangement 13 comprises a plurality of optic couplers 13a, each configured for splitting the receiving light waves two paths. Thus, the coupling arrangement 13 functions as a power splitting tree such that light waves being received by the single receiving waveguide 12 is split into several branches, and each branch is then fed to a tunable phase shifting device 4, such that the receiving light is distributed to each optical antenna 11.

The phase difference measurement device 1 facilitates measurement and control of the phase difference between optical signals of two adjacent waveguides in the OPA architecture. As discussed above, the differential phase between antennas is measured using interferometry. This facilitates controlling the phase of the light waves transmitting by the array in a more accurate manner. This, in turn, facilitates more accurate control of the direction of the light waves being emitted by the antennas 11.

In embodiments, the phased array 10 also comprises a light source (not shown in FIG. 4), such as a laser, arranged and configured to generate and transmit a light wave to the receiving waveguide 12. An example of the laser is configured to generate light waves having a wavelength that is between 300 nm-1000 nm, such as wavelengths around 905 nm.

The phase difference measurement device 1 of the phased array 10 forms a compact structure. The plurality of optical waveguides 2 extend from the proximal portion to the distal portion in an X direction. This is illustrated in the close-up view of FIG. 6, which shows a portion of the phase difference measurement device 1 of the phased array 10 of FIG. 4. As seen in FIG. 6, two adjacent phase interrogators 5 are arranged in the first plane at different positions along the X direction. For example, a first phase interrogator 5′ configured to couple light from optical waveguides 2a and 2b is arranged at a first position, X1, along the X direction. A second phase interrogator 5″ configured to couple light from optical waveguides 2b and 2c is arranged at a second position, X2, along the X direction. A third phase interrogator 5′″ configured to couple light from optical waveguides 2c and 2d is arranged at the first position, X1, along the X direction. Consequently, the phase interrogators 5 are alternatively arranged at a first and a second position along the X-axis so as to form a more compact structure.

In some embodiments, it may be useful to know the power level of the light in a particular optical waveguide 2. This can be achieved by sweeping the phase shift in one of the optical waveguides with a phase-shifting device earlier in the tree of the phased array 10. By sweeping the phase over a 2pi phase shift, constructive interference can be measured. This, in turn, facilitates determining and/or calibration of the actual power in the optical waveguide 2. The minimum measured power in such a phase shift sweep may facilitate the evaluation of the imbalance in the power distribution, which can, in some cases, be an important parameter to consider in the design of phase-shifting devices. This may facilitate not only modulating the phase of the light sent to the different antennas but may also facilitate actively varying the amplitude if suitable amplitude modulators are included in the splitting tree.

While some embodiments have been illustrated and described in detail in the appended drawings and the foregoing description, such illustration and description are to be considered illustrative and not restrictive. Other variations to the disclosed embodiments can be understood and effected in practicing the claims, from a study of the drawings, the disclosure, and the appended claims. The mere fact that certain measures or features are recited in mutually different dependent claims does not indicate that a combination of these measures or features cannot be used. Any reference signs in the claims should not be construed as limiting the scope.

What is claimed is:

1. A phase difference measurement device for optical phased arrays, the phase difference measurement device comprising:
at least two optical waveguides arranged in parallel in a first plane, wherein each optical waveguide comprising a proximal portion and a distal portion, wherein the proximal portion of at least one of the at least two optical waveguides further comprises a phase-shifting device configured to induce a phase shift of a light wave being transmitted in the phase difference measurement device;
at least one phase interrogator device arranged in the first plane between two neighboring optical waveguides of the at least two optical waveguides, wherein the phase interrogator device is configured to couple light from the two neighboring optical waveguides to interfere in the phase interrogator to generate an interference light wave; and
at least one photodetector configured to detect the interference light wave, wherein the least one photodetector is arranged in a second plane other than the first plane.

2. The phase difference measurement device according to claim 1, further comprising a control unit configured to control the phase-shifting device such that the phase is shifted with a value based on information of the detected interference light wave in the at least one photodetector.

3. The phase difference measurement device according to claim 2, wherein the control unit comprises integrated circuits constructed by CMOS technology.

4. The phase difference measurement device according to claim 2, wherein the control unit is configured to control the phase-shifting device such that the phase shift between the at least two optical waveguides is kept within a predefined interval.

5. The phase difference measurement device according to claim 2, wherein the control unit comprises integrated circuits constructed by CMOS technology.

6. The phase difference measurement device according to claim 1, wherein the at least one phase interrogator device is configured to direct the interfered light in a direction toward the at least one photodetector in the second plane.

7. The phase difference measurement device according to claim 6, wherein the at least one phase interrogator comprises a reorientation portion in the form of a grating mirror or a lattice of scatterers configured to scatter the interfered light wave toward the at least one photodetector in the second plane.

8. The phase difference measurement device according to claim 1, wherein the at least one photodetector comprises a PN-diode.

9. The phase difference measurement device according to claim 1, wherein at least one phase-shifting device of the at least two optical waveguides is a thermo-optic phase shifter.

10. The phase difference measurement device according to claim 1, further comprising a plurality of optical waveguides, wherein a phase interrogator device is arranged between each pair of neighboring optical waveguides.

11. The phase difference measurement device according to claim 10, wherein the plurality of optical waveguides extend from the proximal portion to the distal portion in an X direction, and wherein two adjacent phase interrogators are arranged in the first plane at different positions along the X direction.

12. A phased array comprising:
at least one phase difference measurement device according to claim 1;
an optical antenna arranged on distal portions of the optical waveguides of the at least one phase difference measurement device;
a receiving waveguide for receiving light waves that are to be transmitted by the optical phased array; and
a coupling arrangement configured to transmit and split the light waves received by the receiving waveguide to the phase-shifting devices of the at least one phase difference measurement device.

13. The phased array according to claim 12, wherein the coupling arrangement comprises a plurality of optic couplers configured for splitting receiving light waves into at least two paths.

14. The phased array according to claim 12, wherein the optical antennas correspond to leaky-wave antennas (LWA).

15. The phased array according to claim 12, wherein the coupling arrangement comprises a plurality of optic couplers configured to split receiving light waves into at least two paths.

16. A phased array according to claim 12, wherein the phased optical array comprises at least 1000 optical antennas.

17. The phased array according to claim 12, wherein the at least one phase difference measurement device further comprises a control unit configured to control the phase-shifting device such that the phase is shifted with a value based on information of the detected interference light wave in the at least one photodetector.

18. The phased array according to claim 17, wherein the control unit comprises integrated circuits constructed by complementary metal-oxide-semiconductor (CMOS) technology.

19. The phase difference measurement device according to claim 17, wherein the control unit is configured to control the phase-shifting device such that the phase shift between the at least two optical waveguides is kept within a predefined interval.

20. A light detection and ranging (LIDAR) system for measuring a distance to a target, the LIDAR system comprising:
a light source for generating light waves for illuminating the target;
an optical phased array according claim 12 for controlling the illumination direction of the light waves generated by the light source; and
a sensor device for measuring reflected light associated with emitted light waves from the target.
